(19) United States
(12) Patent Application Publication
(10) Pub. No.: US 2004/0075367 A1
(43) Pub. Date: Apr. 22, 2004

(54) Piezoelectric power generating device for a single cylinder engine

(76) Inventor: Gordon E. Rado, Plymouth, WI (US)

Correspondence Address: BAKER & DANIELS, 111 E. WAYNE STREET, SUITE 800, FORT WAYNE, IN, 46802

(21) Appl. No.: 10/430,475

(22) Filed: May 6, 2003

Related U.S. Application Data
(60) Provisional application No. 60/419,246, filed on Oct. 17, 2002.

(51) Int. Cl. H02N 2/00

(52) U.S. Cl. 310/339

(57) ABSTRACT

An engine having a piezoelectric device attached thereto for production of electrical power to be used by the engine. The piezoelectric device extends from the engine to the mass in a direction transverse to the direction of piston travel. The piezoelectric device has a mass attached at an extremity thereof, which oscillates during engine operation to produce a natural frequency coincident with the operating speed of the engine. The resultant attenuation will maximize the power output from the piezoelectric generating device.

### BACKGROUND OF THE INVENTION

1. Field of the Invention

The present invention relates to small internal combustion, single or twin cylinder engines, and specifically to the generation of electrical power for such small internal combustion engines.

2. Description of the Related Art

Small internal combustion engines, specifically single cylinder internal combustion engines, inherently have problems not associated with larger internal combustion engines, such as those used in automobiles and larger vehicles. Single cylinder internal combustion engines are inherently unbalanced, or, have undesirable vibrations associated therewith. Such vibrations may become problematic in the usage and operation of the single cylinder engine and may seriously affect engine performance. The vibrations are however predictable having an expected magnitude or frequency, and could possibly be attenuated.

Another requirement of internal combustion engines is that electrical power is needed for charging the engine battery. Previously, devices to generate such power used shaft power from the crankshaft of the engine to generate the necessary electrical power; however, the usage of such shaft power decreases the amount of otherwise usable power for equipment associated with the engine. Furthermore, such conventional devices may entail the usage of magnets and/or windings, which in turn generate an electromagnetic field. The electromagnetic field may interfere with other devices, or the windings may short out during operation of the engine. Additional cost is incurred through the installation of these devices using shaft power to operate to the engine and the additional parts required in assembly of the engine.

A previous attempt at generation of power associated with internal combustion engines has included the use of a piezoelectric device to convert the inherent vibrations of the internal combustion engine into electrical energy, as shown by U.S. Pat. No. 5,003,518 (Felder). The electric energy is used to switch on a stopwatch timing unit to measure the length of time the engine is operating. The conversion of vibrations to electrical energy as disclosed by Felder is disadvantageous in that the vibrations are not attenuated and that the power produced is not maximized.

It is desired to provide a mechanism to assist in balancing the single cylinder internal combustion engine, attenuating vibrations, while generating electric energy without using power from the crankshaft.

### SUMMARY OF THE INVENTION

The above-described shortcomings and problems are overcome by providing a single cylinder engine with a piezoelectric device being attached thereto for production of electrical power to be used by the engine. The piezoelectric device has a mass attached at the upper extremity that oscillates in reaction to engine vibration at a natural resonant frequency coincident with the operating speed of the engine. The piezoelectric device extends from the engine to the mass in a direction transverse to the direction of piston travel within the single cylinder, so that the resultant attenuation will maximize the power output from the piezoelectric generating device. In addition, a rectifier may be included to convert the AC power to DC power in order to charge the engine battery.

Advantageously, the structure of the piezoelectric device utilizes the inherent vibratory action of the single cylinder engine to produce the electrical power necessary to charge the engine battery without using shaft power from the crankshaft that could otherwise be used to operate equipment powered by the engine. Consequently, the generation of electrical power does not require magnets or windings which would produce the undesirable electromagnetic field or potentially fail.

The mechanism further lowers the cost associated with such single cylinder engines since fewer parts are required, and as a result, fewer parts could fail.

In accordance with the present invention a piezoelectric device has a first end secured to the engine casing and a second end extending away from the casing. A mass is secured to the second end of the piezoelectric device and is movable in response to engine vibration such that the piezoelectric device generates electric energy. The size of the mass is preferably predetermined to maximize the electrical power generated by oscillations of the piezoelectric device. Preferably, the piezoelectric device extends in a direction transverse to axial movement of the piston.

### BRIEF DESCRIPTION OF THE DRAWINGS

The above-mentioned and other features and objects of this invention will become more apparent and the invention itself will be better understood by reference to the following description of an embodiment of the invention taken in conjunction with the accompanying drawings, wherein:

FIG. 1 is a schematic diagram of an engine and power generating device in accordance with the present invention;

FIG. 2 is a side view of a single cylinder internal combustion engine having the piezoelectric device and mass associated therewith in accordance with one form of the present invention; and

FIG. 3 is a top view of the single cylinder internal combustion engine of FIG. 2.

Corresponding reference characters indicate corresponding parts throughout the several views. Although the drawings represent an embodiment of the present invention, the drawings are not necessarily to scale and certain features may be exaggerated in order to better illustrate and explain the present invention. The exemplification set out herein illustrates an embodiment of the invention and such exemplification is not to be construed as limiting the scope of the invention in any manner.

### DETAILED DESCRIPTION

Referring first to FIGS. 2 and 3, single cylinder internal combustion engine 20 is shown as including casing 22 having finned projecting cylinder 24 extending therefrom. Disposed within cylinder 24 is a piston (not shown) reciprocating back and forth therein. The back and forth movement of the piston in the cylinder is represented by double headed arrow 28 (FIG. 2). On the lower portion of housing 22 is flange 30 having circumferentially spaced bolt holes 32 formed therein for connection of engine 20 to an implement, such as a lawn and garden implement. Extending through engine 20 in a direction substantially perpendicular to cylinder 24 is crankshaft 34 having central axis 36.

Attached to casing 22 is piezoelectric device 38 used for the generation of electrical power. Piezoelectric device 38 is directly or indirectly attached to casing 22 at point 40 by any suitable means including soldering, bolting, a bracket, tape, or the like. Piezoelectric device 38 is a known piezoelectric generating device, such as that manufactured by Face International Corporation under the “Thunder” trademark. Piezoelectric device 38 is preferably of the type disclosed in U.S. Pat. No. 5,632,841 (Hellbaum et al.), the complete disclosure of which is expressly incorporated herein by reference. In such piezoelectric devices, the power is generated through the distortion of the piezoelectric device as described in the above incorporated patent.

Piezoelectric device 38 is a layered composite in which individual materials are layered, wherein the bottom layer is stainless steel, the middle layer PZT ceramic, and the top layer aluminum. The layers are bonded to each other by means of an adhesive applied therebetween to form a laminate. As the laminate is autoclaved during processing, the laminate is heated and compressed, allowed to cook and then cooled to room temperature. During cooling, the mismatch in coefficients of thermal expansion cause the material and ceramic layers to contract at different rates thereby putting the ceramic in compression at room temperature. This results in a pre-stress internal to the individual layers which provides the characteristic curvature of the device.

The design of piezoelectric device 38 produces relatively high voltage outputs for a given displacement amplitude, thereby simplifying system design and packaging.

At upper end 42 of piezoelectric device 38, mass 44 is secured thereto by any suitable means including soldering, bolting, a bracket, tape, or the like. Mass 44 is preferably a dense material such as a block of lead, steel, or copper. Mass 44 is shown in FIG. 2 in a resting position with piezoelectric device 38 extending from engine 20 at point 40 to mass 44 in a direction substantially perpendicular to the direction of movement of the piston as indicated by arrow 28. The transverse positioning of piezoelectric device 38 relative to the piston movement maximizes deflection and the resulting output of the device. During engine operation, mass 44 oscillates in the direction of arrows 46 and 48 to either side of the resting position. Mass 44 is sized such that a natural resonance frequency is produced during oscillation of piezoelectric device 38 and mass 44 that is substantially identical to the operating speed of engine 20.

The natural frequency of piezoelectric device 38 and mass 44 is determined by the equation

$${ω}_{n} = \sqrt{\frac{K}{M}}$$

wherein K is equal to the stiffness of the piezoelectric device, and M equals the value of mass 44 plus the value of approximately half the mass of piezoelectric device 38. The desired natural frequency ωₙ, if the mass 44 is sized correctly, will then be substantially identical to the engine operating speed.

By sizing mass 44 to develop a natural frequency approximate the operating speed of engine 20, the power output of piezoelectric device 38 is maximized, as desired. Furthermore, by correctly sizing mass 44, the vibration of engine 20 may be attenuated, thereby eliminating the undesirable consequences and potential damage to engine 20 and its respective components resulting from such vibration.

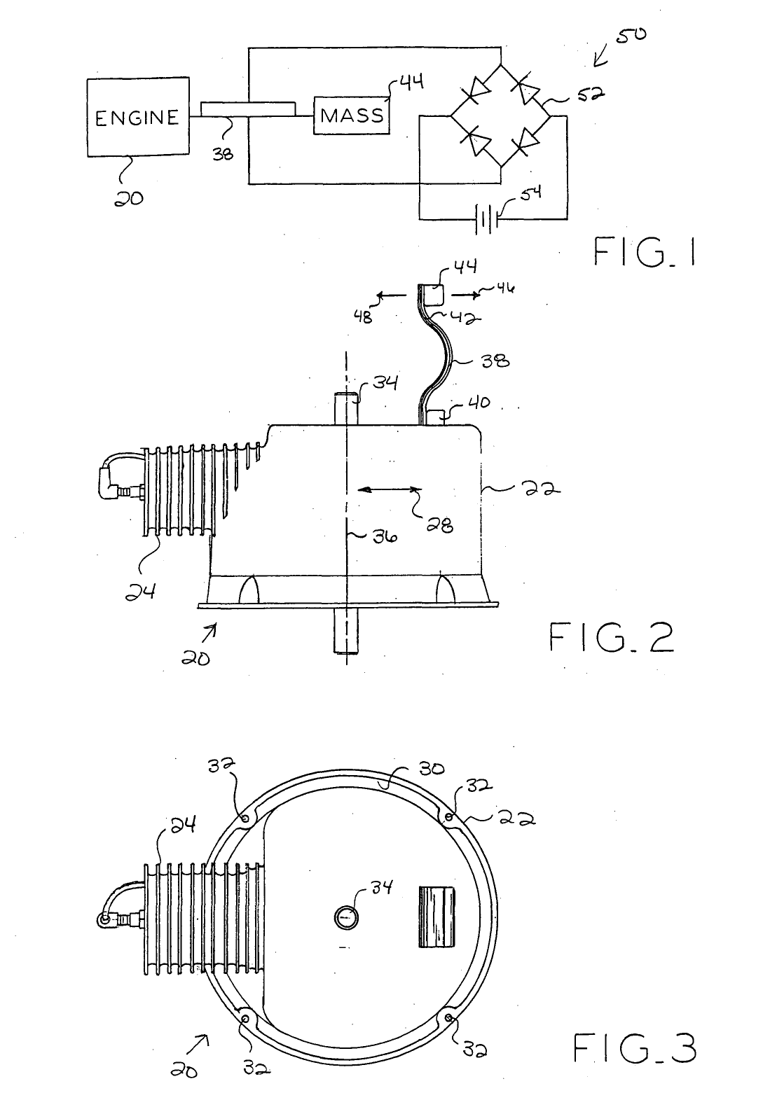

Referring now to FIG. 1, a schematic diagram of overall system 50 is shown as including engine 20 and mass 44 with piezoelectric device 38 located therebetween. As can be seen, piezoelectric device 38 is connected to bridge rectifier 52 which serves to convert the alternating current developed by piezoelectric device 38 into direct current which may then be utilized to charge engine battery 54.

Piezoelectric device 38 enables charging of battery 54, as would occur in an internal combustion engine using a more conventional alternator. Piezoelectric device 38 eliminates the need for magnets and windings of a generator, thereby eliminating the creation of an electromagnetic field which may be undesirable in certain instances. The possibility of the windings short circuiting during operation of engine 20 is further eliminated.

Piezoelectric device 38 uses the inherent vibratory action of the engine to operate, eliminating the need to use power from crankshaft 34 to develop the necessary electrical energy to charge battery 54, for example.

While this invention has been described as having exemplary structures, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An internal combustion engine comprising:
a piezoelectric device having two ends, a first said end secured to said engine, and a second said end extending away from said engine; and
a mass secured to said second end of said piezoelectric device, said mass movable responsive to engine vibration, whereby electric energy is generated by said piezoelectric device.

2. The engine of claim 1 wherein the size of said mass is predetermined to maximize said electrical power generated by oscillations of said piezoelectric device.

3. The engine of claim 1 wherein said piezoelectric device and said mass oscillate at a natural frequency related to the operating speed of the internal combustion engine.

4. The engine of claim 1 further comprising a battery electrically connected to said piezoelectric device.

5. The engine of claim 4 further comprising a rectifier located between said battery and said piezoelectric device, said rectifier converting electrical power produced by said piezoelectric device from alternating current to direct current.

6. The engine of claim 1 wherein said frequency is substantially equal to the square root of the numerical value of said piezoelectric device stiffness divided by the sum of said mass numerical mass quantity and one-half of said piezoelectric device numerical mass quantity.

7. The engine of claim I wherein said piezoelectric device is arcuate and comprises a piezoelectric ceramic layer that is in compression at room temperature.

8. The engine of claim 1 wherein said piezoelectric device is curved and pre-stressed.

9. An internal combustion engine comprising:
a piezoelectric device having two ends, a first said end secured to said engine, and a second said end extending away from said engine; and
a mass secured to said second end of said piezoelectric device, said mass movable responsive to engine vibration, whereby the size of said mass is predetermined to maximize electrical power generated by oscillations of said piezoelectric device.

10. The engine of claim 9 wherein said piezoelectric device and said mass oscillate at a natural frequency coincident with the operating speed of the internal combustion engine.

11. The engine of claim 9 further comprising a battery electrically connected to said piezoelectric device.

12. The engine of claim 11 further comprising a rectifier located between said battery and said piezoelectric device, said rectifier converting electrical power produced by said piezoelectric device from alternating current to direct current.

13. The engine of claim 9 wherein said frequency is substantially equal to the square root of the numerical value of said piezoelectric device stiffness divided by the sum of said mass numerical mass quantity and one-half of said piezoelectric device numerical mass quantity.

14. The engine of claim 9 wherein said piezoelectric device is arcuate and comprises a piezoelectric ceramic layer that is in compression at room temperature.

15. The engine of claim 9 wherein, said piezoelectric device is curved and pre-stressed.

16. An internal combustion engine comprising:
a block defining at least one cylinder therein;
a piston disposed in said cylinder, said piston moving axially in said cylinder;
a piezoelectric device connected directly or indirectly to said block and extending in a direction transverse to axial movement of said piston; and
a mass coupled to said piezoelectric device, said mass movable responsive to engine vibration, said piezoelectric device and said mass oscillating at a natural frequency coincident with a selected operating speed of the internal combustion engine, whereby electrical power is generated.

17. The engine of claim 16 wherein the size of said mass is predetermined to maximize said electrical power generated by oscillations of said piezoelectric device.

18. The engine of claim 16 further comprising a battery electrically connected to said piezoelectric device.

19. The engine of claim 18 further comprising a rectifier located between said battery and said piezoelectric device, said rectifier converting electrical power produced by said piezoelectric device from alternating current to direct current.

20. The engine of claim 16 wherein said frequency is substantially equal to the square root of the numerical value of said piezoelectric device stiffness divided by the sum of said mass numerical mass quantity and one-half of said piezoelectric device numerical mass quantity.

21. The engine of claim 16 wherein said piezoelectric device is arcuate and comprises a piezoelectric ceramic layer that is in compression at room temperature.

22. The engine of claim 16 wherein, said piezoelectric device is curved and pre-stressed.
